(19) United States
(12) Patent Application Publication
(10) Pub. No.: US 2004/0003351 A1
(43) Pub. Date: Jan. 1, 2004

(54) Navigating a resource browser session

(75) Inventors: Ralph Sommerer, Cambridge (GB); Robert Tucker, Cambridge (GB); Natasa Milic-Frayling, Cambridge (GB); Jurij Leskovec, Horjul (SI)

Correspondence Address: LEE & HAYES PLLC, 421 W RIVERSIDE AVENUE SUITE 500, SPOKANE, WA, 99201

(73) Assignee: Microsoft Corporation

(21) Appl. No.: 10/186,933

(22) Filed: Jun. 28, 2002

(51) Int. Cl. G06F 15/00

(52) U.S. Cl. 715/517; 715/500

(57) ABSTRACT

A browser session navigation tool allows a user to browse previously viewed resource pages during a browser session. Each visit to a resource page results in creation of a visit data structure that references (directly or indirectly) the resource page content. The previously viewed resource pages are graphically represented by navigationally related visit nodes displayed in one or more trails or trees, which graphically illustrate the navigation from resource page to resource page. Resource page content may be displayed in the visit nodes, such as a thumbnail image of the resource page. In contrast to typical browser history lists, navigation branches are not truncated. Instead, all previously viewed resource pages are recorded in archive data storage and are displayed in linear trails and branching tree structures of visit nodes. Archived resource page content may be indexed and annotated to be searchable by text, color, and other visual aspects, thereby allowing a user to search the rich record of their browsing experience during the browsing session.

### RELATED APPLICATIONS

The application is related to U.S. patent application Ser. No. ______, entitled “RESOURCE BROWSER SESSIONS SEARCH” [Docket No. MS#192134.1/40062.184US01], and U.S. patent application Ser. No. ______, entitled “HYPERLINK PREVIEW UTILITY AND METHOD” [Docket No. MS#192135.1/40062.185US01], both of which are specifically incorporated herein for all that they disclose and teach.

### TECHNICAL FIELD

The invention relates generally to resource browsers, and more particularly to navigating through resources visited during a resource browser session.

### BACKGROUND OF THE INVENTION

Using a browser, a user may visit a large number of web sites in a single browser session. At each web site, a user may visit multiple web pages during the browser session. In some cases, a description and an address (e.g., the Uniform Resource Locator or URL) for a visited web page are saved in a sequential, stack-based “history” list, possibly allowing a user to return to a previously visited web page by selecting its description from the history list. In addition, a user can traverse the web pages in the standard history list by selecting the forward or backward buttons provided by the browser. Browsers can also be used to traverse a file system, and the history list can be used to return to a previously visited directory or file within the file system. Generally, browsers may be said to browse resources, whether on the Web, in a file system, or in some other type of data storage.

Some browsers use a caching mechanism and store some or all elements of visited web pages. The main purpose of the cache is to speed up repeated loading of the page content. If a page is loaded from a web site marked as non-cacheable, no instance of such a page is stored in the cache and thus has to be loaded from the web site every time its URL is requested.

Existing history lists present disadvantages that limit their usefulness. Forward/backward traversal, without relevant visual feedback, can be confusing to some users and can be time-consuming, especially on a slow connection if the page content is not cached. Furthermore, existing history lists tend to provide a limited amount of information about the previously visited resource, making it difficult for a user to know which resource to select from the history list. For example, a history list may merely indicate a top-level URL (e.g., “www.foobar.com”) or web page name (“Welcome to FooBar's Web Site!”), which may have little meaning to the user. As such, existing approaches fail to provide enough information and flexibility to maximize the usefulness of history lists in browsers.

Another disadvantage is that existing history lists tend to drop entire threads of previously visited resources. For example, if a user traverses down a hierarchy of resources (e.g., a directory structure) one level at a time to a resource referred to as “c:\FirstLevel\SecondLevel\ThirdLevelA”, presses the backward key once to return to “c:\FirstLevel\SecondLevel”, and then browses to “c:\FirstLevel\SecondLevel\ThirdLevelB”, the browser typically drops or truncates the visit to the ThirdLevelA from the history list. Accordingly, a history list fails to provide a complete representation of the browser session navigation.

Yet another disadvantage is that existing approaches do not display the resource that the user had actually viewed earlier in the browser session. For example, if a user attempts to return to a local news web page by selecting it from a history list, the browser requests the web page using its URL and retrieves an updated version of the web page from the web. As such, the web page that is displayed is a current version of the local news, which may have changed from the version that the user remembered seeing earlier in the browser session. That is, the news article in which the user was interested may have been replaced with a more current article. This undesirable updating may be even more prevalent with regard to advertisements, which can frequently change from visit to visit. If the user wishes to return to a previously viewed advertisement using an existing history list, they are likely to find a different advertisement in its place.

### SUMMARY OF THE INVENTION

Embodiments of the present invention solve the discussed problems by providing a browser session navigation tool that allows a user to browse a complete record of user navigation. A browser session navigation tool can include the fully archived content of the previously viewed resource pages, which is particularly advantageous when the content of the resource page is dynamic or there is some other need to archive the resource data (e.g., in order to share the browsed content with users who do not have access to the resources, etc.). Each visit to a resource page results in creation of a visit data structure that references (directly or indirectly) the resource page content that has been archived by the tool in archive storage. The previously viewed resource pages are represented by navigationally related visit nodes displayed in one or more trails or trees, which graphically illustrate the navigation from resource page to resource page. Resource page content may also be displayed in the visit nodes, such as a thumbnail image of the resource page. In contrast to typical browser history lists, navigation branches are not truncated. Instead, content of substantially all previously viewed resource pages is recorded in archive data storage and displayed in linear trails or branching tree structures of visit nodes. Archived resource page content may be indexed and annotated to be searchable by text, color, and other visual aspects, thereby allowing a user to search the rich record of their browsing experience during the browser session.

Advantages of the browser session navigation tool can be observed with or without the persistence of the content and, thus, regardless of whether the content is static or dynamic. The linear exposition of the navigation is useful, even if the navigation data is not structured linearly. That is, the mere sequence of navigation nodes displayed linearly can provide useful feedback to a user during a browser session.

In implementations of the present invention, articles of manufacture are provided as computer program products. One embodiment of a computer program product provides a computer program storage medium readable by a computer system and encoding a computer program that records browser navigation activity. Another embodiment of a computer program product may be provided in a computer data signal embodied in a carrier wave by a computing system and encoding the computer program that records browser navigation activity.

The computer program product encodes a computer program for executing on a computer system a computer process for recording browser navigation activity. The computer system includes an archive memory and is connected to a communications network through which a plurality of resource pages is accessible. A navigation event indicating a visit to one of the plurality of resource pages is detected. A visit data structure representing the visit to the resource page is populated responsive to the detecting operation. The visit data structure is recorded. A page data structure that references content of the resource page is referenced, responsive to the detecting operation. The content of the resource page is persisted in the archive memory.

In another implementation of the present invention, a method of recording browser navigation activity is provided. The computer system includes an archive memory and is connected to a communications network through which a plurality of resource pages is accessible. A navigation event indicating a visit to one of the plurality of resource pages is detected. A visit data structure representing the visit to the resource page is populated responsive to the detecting operation. The visit data structure is recorded. A page data structure that references content of the resource page is referenced, responsive to the detecting operation. The content of the resource page is persisted in the archive memory.

In yet another embodiment of the present invention, a resource browser session navigator for recording browser navigation activity is provided. A navigation manager module detects a navigation event indicating a visit to a resource page. A resource page manager module populates a visit data structure representing the visit to the resource page and references in the visit data structure a page data structure that references content of the resource page, the content of the resource page being persistent in the archive memory.

These and various other features as well as other advantages, which characterize the present invention, will be apparent from a reading of the following detailed description and a review of the associated drawings.

### BRIEF DESCRIPTION OF THE DRAWINGS

FIG. 1 depicts an exemplary user interface for a browser session navigation tool in an embodiment of the present invention.

FIG. 2 illustrates a tree of web page nodes in an exemplary browser session.

FIG. 3 depicts an alternative exemplary user interface for a browser session navigation tool in an embodiment of the present invention.

FIG. 4 depicts an enlarged view of a thumbnail selected from a browser navigation bar in an embodiment of the present invention.

FIG. 5 depicts an enlarged view of a thumbnail selected from a browser session navigation map in an embodiment of the present invention.

FIG. 6 depicts an architectural diagram of a browser session navigation tool in an embodiment of the present invention.

FIG. 7 illustrates functionality of a navigation manager in an embodiment of the present invention.

FIG. 8 illustrates functionality of a resource page manager in an embodiment of the present invention.

FIG. 9 illustrates a resource data view of a visit in an embodiment of the present invention.

FIG. 10 illustrates two exemplary requests for a resource page in an embodiment of the present invention.

FIG. 11 illustrates processes and services of a browser session navigation tool in an embodiment of the present invention.

FIG. 12 illustrates an exemplary system useful for implementing an embodiment of the present invention.

### DETAILED DESCRIPTION OF THE INVENTION

A browser session navigation tool allows a user to browse previously viewed resource pages during a browser session. Each visit to a resource page results in creation of a visit data structure that references the resource page content. The previously viewed resource pages are represented by visit nodes and navigationally-related visit nodes displayed in one or more trails or trees, which graphically illustrate the navigation from resource page to resource page. Resource page content may also be displayed in the visit nodes, such as a thumbnail image of the resource page. In contrast to typical browser history lists, navigation branches are not truncated. Instead, content of substantially all previously viewed resource pages is recorded in archive data storage and displayed in linear trails or branching tree structures of visit nodes. Archived resource page content may be indexed and annotated to be searchable by text, color, and other visual aspects, thereby allowing a user to search the rich record of his or her browsing experience during the browser session. User annotations may refer to the page (i.e. as identified by the URL), a visit to the page, the browser window session, or a sequence of pages seen during navigation. Navigational sequences may also be saved and retrieved for future use. Alternatively, a rich navigation record is stored and used to dynamically generate a desired type of navigational sequences.

Furthermore, an embodiment of the present invention records and facilitates traversal of the structure of previously visited resource content. Resource content can be a collection of possibly inter-dependent constituent parts, such as a single monolithic web page, a multi-document web page consolidating content from multiple resources, or a sequentially related group of resources (e.g., related via a hyperlink). Navigation can be initiated or continued from various nodes within a given browser session through a graphical view (e.g., a sequence of thumbnails or a tree-like graph of thumbnails) that visually depicts the navigational relationships among previously visited resources.

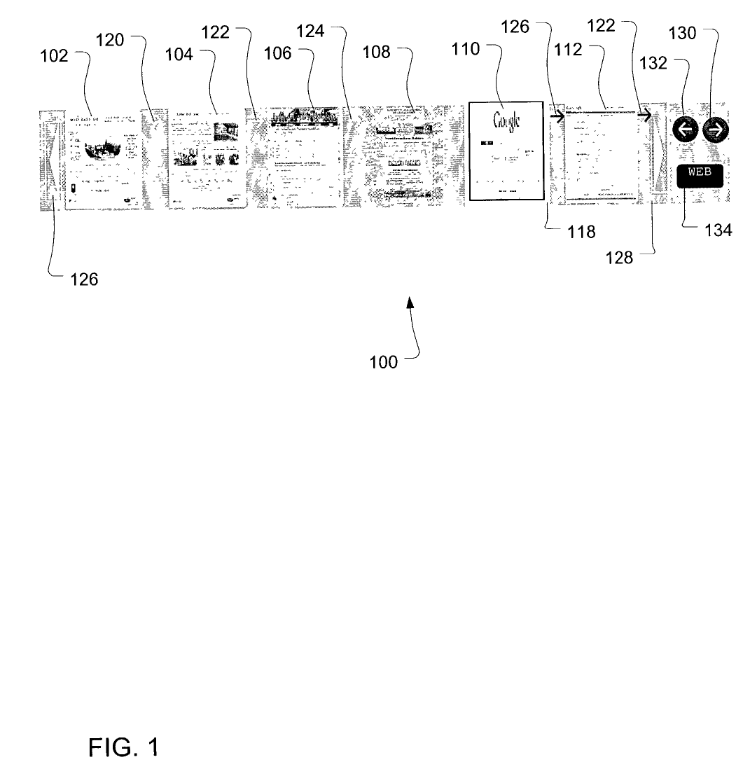

FIG. 1 depicts an exemplary user interface for a browser session navigation tool in an embodiment of the present invention. The browser session navigation bar 100 may be displayed near the top of a browser (not shown), perhaps as a slide-out or pop-up control, although alternative locations and behavior of the browser session navigation bar 100 are contemplated with the scope of the present invention. In one embodiment, the browser session navigation bar 100 is integrated into the browser, although in alternative embodiments, the browser session navigation bar 100 may be implemented as a stand-alone application that interfaces with the browser or with browser data to provide browser session navigation functionality.

The browser session navigation bar 100 is depicted in FIG. 1 as showing one or more sequences or “trails” of visit nodes as thumbnail images of resource pages, such as web pages retrieved from the Web during the browser session. However, it should be understood that resource pages may also include non-web documents, directory trees, multimedia elements, multi-document web pages, devices, applications, services, and other known resources. In addition, although thumbnail images of the resource pages are displayed in FIG. 1, other identifiers of the resource pages may be displayed including without limitation labels, URLs, and icons.

Generally, a resource page is a page displayed in or otherwise accessed by a browser (e.g., even if the page is hidden) from a resource page location. A resource page location may be described by a resource page location identifier, e.g., a URL or a local pathname to a resource page. In an alternative embodiment, a resource page location identifier is used to uniquely describe an instance of a resource page, such by combining of a URL and a time stamp of document access, or by generating a document content signature (e.g., a resource modification date or a more sophisticated characterization of the resource content, such as a CRC (Cyclic Redundancy Check) generated from the resource).

A resource page may be a multi-document resource page having multiple frames and may contain any number of component resource documents. Component resource documents are elements of resource page that are referenced therein by resource document identifiers and are separately retrieved from other resource locations identified by the resource document identifiers. For example, a web page may include component web documents that are referenced in the HTML document that defines the web page, each component web document being identified by its own URL or local pathname. The browser retrieves and loads the HTML document to display the web page and separately retrieves the component web documents from the referenced resource locations for display.

A browser generally retrieves a resource page from a local or remote resource page location based on a resource page identifier and displays the resource page in a main browser window. For example, a web page resource may be retrieved from a web site via a URL or a local document may be retrieved from the local file system via a pathname. Alternatively, a resource including an installation application or applet may be downloaded to the client computer system or otherwise accessed by the client computer system. Such retrievals are termed “live retrievals” because they retrieve the resource page in its current state (i.e., the state in which the resource page is served up by the web site or file system). For example, a user can retrieve a live web page by entering its URL into an address box of the browser, by following its link, or by submitting another HTTP request that results in a retrieval of the live web page from the Web, such as a search page query resulting in retrieval of a search results web page.

However, in association with a browser session navigation tool, a resource page may be accessed by the browser (e.g., retrieved and displayed in the main browser window) either as a result of a “live retrieval” of the resource or as a result of an “archived retrieval” of the resource. An “archived retrieval” occurs when the resource page is retrieved from archival data storage containing content and parameters of previously retrieved resource pages. For example, a user retrieves a sequence of live web pages A, B, and C, and then uses a “back” feature for the browser to traverse backward through the sequence of web pages. In an embodiment of the invention, each web page visited using the “back/forward” features of a browser are retrieved from archival data storage, not from the Web. In this manner, the user is re-presented with exactly the same web page that he or she had viewed previously, not with an updated or live web page that may have changed in some manner. It should be understood that archived retrieval differs from standard history lists, in which history list entries merely correspond to URLs that are used to live retrieve an updated web page, not an archived version of the web page.

In this example, it should also be understood that archived retrieval differs from the known retrieval of web page resources (e.g., image files) from a browser cache. The browser cache is a current mechanism to speed up loading of a web page. A browser cache is useful, for example, when images within a web page have already been retrieved and cached from previous visits. Such images are typically referenced in the main web page document and retrieved separately. If cached in the local client computer system's browser cache, these images may be re-used from the cache without being re-retrieved from the Web. However, with a standard browser cache, the main web page document may still be live retrieved from the location indicated by its URL. Only cached and unchanged web pages and images are retrieved from the cache instead of via a fresh live retrieval. Changes to the main document will still be reflected by live retrieval of the main document. It should also be understood that the browser cache does not address issues of navigation or dynamic content.

In contrast, archived retrieval in an embodiment of the present invention results in retrieval of the rich resource page content (e.g., representations of both the main page document and the component resources referenced within) from a content storage archive, based on a unique resource page identifier. In embodiments of the present invention, the archived resource pages are partitioned into logical units and displayed as visit nodes in one or more sequential “trails” of nodes or in a hierarchical “tree” of nodes. Generically, both types of navigation displays (i.e., trails and trees) represent a logical “trail” of navigation.

However, it should also be understood that user navigation over resource pages within a single browser session or across multiple browser session, whether archived or not, may be displayed in trails or trees of nodes. In one embodiment, a trail or tree starts by the user's explicit specification of a URL, use of a URL from the Bookmark list, or by executing a link from another application or document, such as an email application. In another embodiment, the trail or tree can also begin with a search request or other service access, including the history list or archive storage. The trails can be presented in the sequential format, as a list of visits to the accessed resource pages in the order of access time, or, if the resource is structured (e.g., using hyperlinks), the trail can be presented as a tree structure showing the visit nodes as the structure of navigation in the time order of page access.

Displayed within the browser session navigation bar 100 are six visit nodes 102, 104, 106, 108, 110, and 112 representing archived resource pages that have been previously retrieved during the current browser session. In one embodiment, a browser session is defined as the time from initiation of the browser or creation of the browser window (e.g., the main browser window in which a web page is displayed) to the termination of the browser or browser window. Browser sessions may also be annotated by a browser session identifier. Therefore, specific browser session navigation activity may be recalled by searching on the basis of the browser session identifier. Furthermore, the browser session identifier may be used to label a specially saved navigation sequence for later retrieval or communication to another person (e.g., via email), etc.

However, in alternative embodiments, the browser session is defined to include all visit nodes from all previously visited resource pages from all browser windows of a given browser or from multiple browsers. For example, if a user is browsing using three different browser windows, the browser session navigation bar 100 may display three rows of visit nodes, one for each browser window.

In addition, a browser session navigation tool may allow a user to customize the definition of a browser session, so as to limit the amount of storage used by the tool. For example, a user may limit the amount of archive storage allocated to the tool or the number or type of resource pages archived. In one exemplary configuration, a user can set the browser session navigation tool to archive only browser sessions or portions of such browser session that are explicitly specified by a user. In other embodiments, the browser session navigation bar 100 displays a single row of nodes in each browser window (e.g., the single row corresponding to the browser window displaying the navigation bar) or combine nodes from all three browser windows into a single integrated navigation bar).

The nodes 110 and 112 are shown with dark arrows 114 and 116, designating the nodes 110 and 112 as nodes within the “active trail”. An active trail is a trail associated with an instance of a resource page that is currently displayed in the main browser window, which resource page is termed the “current resource page”. The visit node corresponding to the current resource page (i.e., visit node 110) is designated by the dark cursor box 118. In one color embodiment of the present invention, the dark arrows 114 and 116 and the dark cursor box 118 are displayed as red. The visit nodes 102, 104, 106, and 108 are shown with light arrows 120, 122, and 124, designating these nodes within an “inactive trail.” An inactive trail is a trail that is not associated with the current instance of the resource page.

Each visit node represents a resource page visited during the browser session. For example, the visit node 102 represents a web page received from a web site and displayed to the user in the main browser window. The arrow 120 indicates that the user navigated to the web page represented by the visit node 104, such as by selecting a hypertext link or by a web page action that results in generation of a new web page (e.g., submission of a search engine query). Another exemplary navigation event may include without limitation form submissions through buttons, etc.

In contrast, FIG. 1 does not show an arrow between visit nodes 108 and 110, indicating that the nodes 108 and 110 are in different trails. The visit node 110 indicates the beginning of a new set of navigationally related visits to resource pages (i.e., a new trail of visits associated by navigation events). To create a new trail in the illustrated embodiment, a user submits, directly or indirectly, a URL specifying a new resource page, although other methods are discussed herein. Accordingly, in the illustrated example of FIG. 1, while visiting the web page represented by the visit node 108, the user may have submitted “www.google.com” in the address box of the browser (i.e., direct submission of the URL), which resulted in retrieval of the displayed web page in the visit node 110 and the start of a new trail. Alternatively, the user may have selected a web page from a Favorites list, a Bookmarks list, or a standard history list within the browser or some other list of resource pages (collectively, indirect submission of the URL). In addition, new web trails may be defined according to heuristics other than submission of a URL (e.g., a submission of a query to a search engine or initiating a request to an on-line service).

Scroll buttons 126 and 128 allow a user to scroll through a session navigation history. When the sequence of visit nodes exceeds the space available in the browser session navigation bar 100, the user may use scroll buttons 126 and 128 to expose additional visit nodes of the browser session.

Forward button 130 and backward button 132 allow a user to navigate through a browser session navigation history (e.g., in case of a simple linear navigation, by moving the cursor box 18 through the node sequence in the direction of the selected button). The forward button 130 and backward button 132 allow the user to retrace the steps (both forward and backward retracing) that the user made during navigation over live or archived content. When the cursor box 118 is moved through the visit node sequence, the web page represented by the current visit node is displayed in the main browser window. However, in contrast to selections from standard history lists, the web page that is displayed in the main browser window is not the result of a “live” update of the web page (e.g., a new HTTP (Hypertext Transport Protocol) request issued to the Web and an HTTP response from the Web with the updated web page). Instead, the displayed web page is retrieved from archival storage so that the displayed web page is the same web page that was previously viewed by the user. (Note that a live updated web page may be different from the web page previously viewed by the user during the browser session and could, therefore, result in the user losing the previously viewed web data for which he or she was looking.) Likewise, the thumbnail images are not live either. They are also retrieved from archive data storage, where they were stored at the time the web page was originally received from the Web. By storing “non-live” resource pages and thumbnail images, the browser session navigation bar 100 provides a rich record of the user's previous navigation experience during the browser session. A “Web” button 134 allows a user to change a web page displayed in the main browser window from “non-live” to “live” by forcing a live retrieval of the web page from the Web. This can be applied to a single navigation step or for all subsequent interactions through the browser, in which case the browser is configured to reload a live page for all user interactions through the browser.

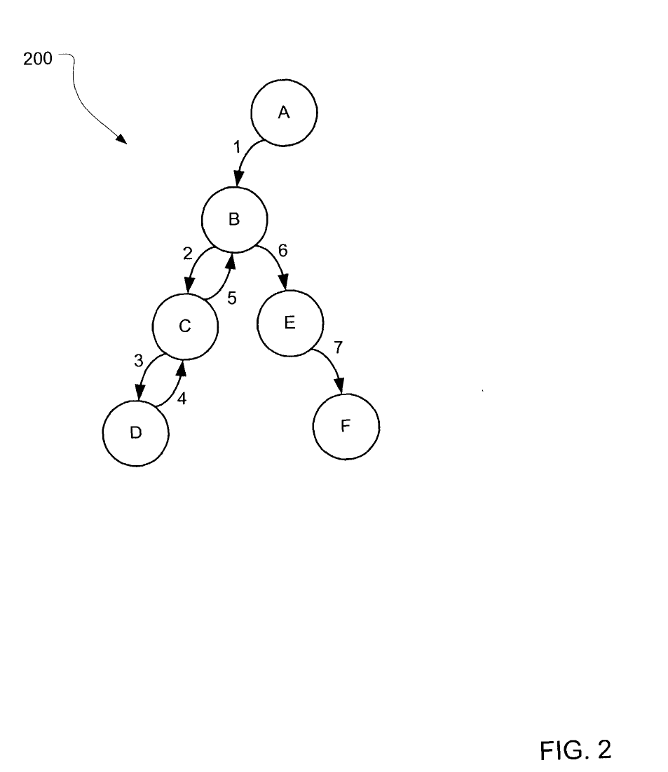

In addition, and also in contrast to existing history lists, the browser session navigation bar 100 maintains a complete record of the user's navigation experience during the browser session. Existing history lists truncate the history to display only single branches of a browser session using traditional stack operations (e.g., push and pop). For example, FIG. 2 illustrates a tree 200 of web pages A-F visited by a user during a browser session, wherein the cardinality of the arcs between nodes represents the order in which the web pages are visited. In a typical scenario, node A would represent the site's Home page. The user could select a link to display the web page of node B in the main browser window. For the purposes of this example, the web page of node B constitutes as web page for a search engine. After submitting a search query into the search engine, a search results web page of node C is displayed in the main browser window. The user can then select a link associated with a search result to traverse to a web page of node D.

Thereafter, the user may decide to modify the search query in the web page of node B. A common method of returning to the search web page is to select the “back” button in the browser twice. The user can then submit a new search query in the search engine web page, which results in the display of a new search results web page of node E in the main browser window. Again, The user can then select a link associated with a search result to traverse to a web page of node F.

Note, however, that a standard history list would list only nodes A, B, E, and F, typically in reverse order after the operation corresponding to arc 7. During the “back” operations corresponding to arcs 4 and 5, nodes C and D were popped off of the history stack and nodes E and F were pushed on the stack during the subsequent operations corresponding to arcs 6 and 7. Therefore, the user can no longer access their browser history to revisit web pages C and D. In other words, only one branch of a branch node is recorded.

In stark contrast to standard history lists, the browser session navigation bar maintains a record of each web page visited during the browser session. Therefore, after the “back” operation corresponding to arc 5, the browser session navigation bar maintains web pages and thumbnail images for nodes A, B, C, and D.

In addition, in one embodiment of the present invention, after the user submits a second search query in the search engine web page of node B (making node B a branch node) and the search results web page of node E is returned, both a duplicate of the branch node B and the new node C are displayed in the browser session navigation bar. Actual use (e.g., selection of a link, submission of a request, etc.) of the web page of node B as a branch node results the duplication of the node B in the browser session navigation bar, whereas merely re-visiting node B without branching does not result in duplication in an embodiment of the present invention. The receipt of the search results web page results in the display of the node E. Likewise, selection of one of the search results causes node F to be displayed. As such, the browser session navigation bar maintains web pages and thumbnail images for visit nodes A, B, C, D, B (duplicate), E and F after the operation corresponding to arc 7.

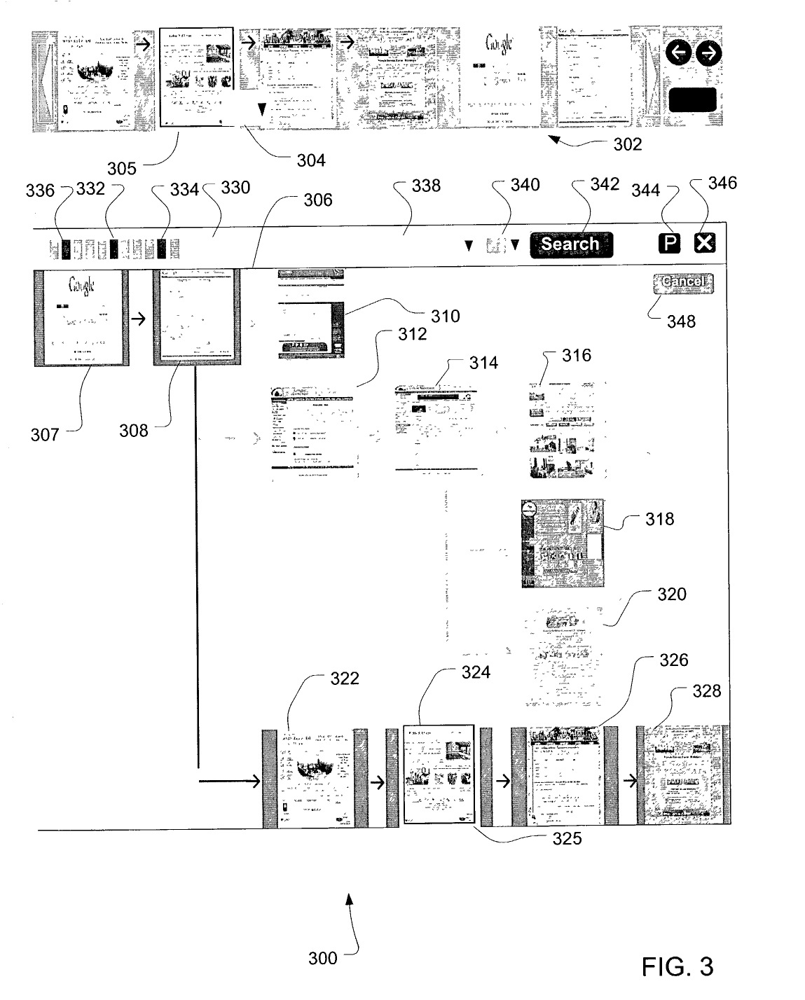

FIG. 3 depicts an alternative exemplary user interface 300 for a browser session navigation bar 302 in an embodiment of the present invention. The pop-up mapping control 304 is triggered for display when the user hovers the mouse cursor outside of a node within the session navigation bar 302. By selecting the “m” symbol in the mapping control 304, a user can view a browser session navigation map 306 of the corresponding trail, as shown in an exemplary map 306. In one embodiment, both the browser session navigation map 306 and the browser session navigation bar 302 can be displayed concurrently (as shown), although in an alternative embodiment, the browser session navigation map 306 and the browser session navigation bar 302 are displayed interchangeably.

The map 306 illustrates the current trail (i.e., the trail containing the current node) in a hierarchical view or tree of browser session navigation. In the illustrated embodiment, a visit node 307 displays a thumbnail image of a search engine web page and represents the first resource page visited in the current trail, which is designated in the navigation bar 302 by the trail having the cursor box 305. A visit node 308 represents the second resource page visited in the trail, which shows the search results web page resulting from the search engine web page of visit node 307. By selecting one of the search results, the user was able to view the web page represented by visit node 310.

In a behavior common to users of search engines, the user was able to use the “back” button to return from the web page represented by the visit node 310 to the search engine results page of visit node 308. From there, the user selected another search result to navigate to the web page represented by visit node 312. The user's subsequent actions resulting in navigation to web pages represented by visit nodes, 314, 316, 318, and 320, as shown in FIG. 3. Upon reaching the web page represented by the visit node 320, the user returned to the search results web page represented by visit node 308.

During this visit to the web page represented by the visit node 308, the user selected yet another search result and navigated to web pages represented by visit nodes 322, 324, 326, and 328, before navigating back to the web page represented by visit node 324, which is designated as the current visit node in both the browser session navigation bar 302 and the browser session navigation map 306. The current visit node 324 in the browser session navigation map 306 is marked using a cursor box 325. The branch having the current visit node is highlighted (in blue in a color display) and with dark arrow segments (i.e., in red in a color display) connecting the visit nodes. If the map exceeds the size of the browser session navigation map window, a scroll bar (not shown) is displayed within the window to allow the user to scroll to hidden portions of the map. In another embodiment, the thumbnail images in the map view are automatically resized so that the complete graph fits a pre-defined view area. As the user changes the size of the view or uses a zoom facility, the size of the thumbnail images changes accordingly.

It should be understood that the navigation browser bar 302 shown in FIG. 3 illustrates the navigation in a sequential order. In a sequential order, a visit node for each resource page is added to the sequence when (1) the visit node represents a new retrieval of the resource page (e.g., a new retrieval and display of a web page; and (2) the visit node represents a navigation branch taken to a new resource page. In the second condition, the branch visit node is duplicated and added to the sequence and then the visit node that the user branched to is added to the sequence. In contrast, the browser session navigation map 306 displays navigation branches using a hierarchical tree view, thereby omitting the duplication of branch visit nodes.

A navigation overview bar 330 displays an overview of the browser session navigation, wherein each vertical bar represents a different trail of the browser session. The dark vertical bar 332 (i.e., a red vertical bar enclosed in a vertical blue box in a color display) represents the trail containing the current visit node. The other two dark vertical bars 334 and 336 (i.e., red vertical bars in a color display) represent other trails that also include the web page represented by the current visit node. The light vertical bars (i.e., green vertical bars in a color display) represent other trails of the browser navigation session that do not include the resource page of the current visit node. A user may select one of the vertical bars to change the browser session navigation map 306 to display the tree for the trail represented by the selected vertical bar.

A user may input text into a search text box 338, which is applied in a typical search engine fashion. Alternatively, the user may select a color or other visual aspect (e.g., frame border type, image, texture, font, etc.) of a previously viewed resource page into a visual aspect dropdown box 340. In this manner, a user can search for a visual aspect that they remember, even if the user does not remember any text from the resource page (e.g., search for the resource page with the green background). If both the search text box 338 and the visual aspect dropdown box 340 are selected, the search parameters (i.e., the text and the visual aspect) are logically combined in the search. A search is initiated by selection of the search button 342. The search is applied to the resource pages of the entire browser session, which is stored in the archive data storage, although limits may be placed on the search, such as limiting the search to the current trail. Search results are indicated by colored vertical bars in the navigation overview (i.e., orange vertical bars in a color display) for trails having resource pages that satisfy the search criteria. Additionally, the visit nodes displayed in the current trail that satisfy the search criteria are also highlighted. For example, matches may be highlighted in the same color or with varied intensity of color to reflect the quality of the match for a particular node with respect to the search query (e.g., color gradation from bright red for a very good match, to orange for a medium match, to yellow for a low relevance match, etc.). In one embodiment, the browser session navigation map 306 changes to display the most recent trail with a hit, making a node that satisfies the search criteria the current visit node (and the cursor in the navigation overview bar 330 is moved to the current trail).

A path button 344 reverts the browser session navigation map 306 back into the browser session navigation bar 302, although in an embodiment of the present invention both the map and the bar may be displayed concurrently (as shown). The “X” control 346 and the Cancel button 348 perform the same function of closing the browser session navigation map 306.

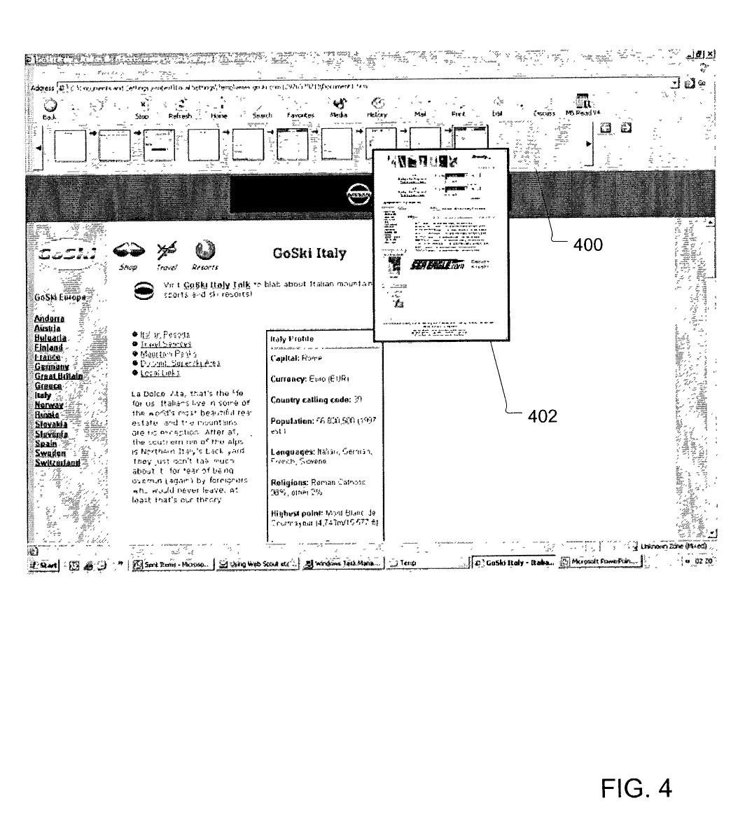

FIG. 4 depicts an enlarged view of a thumbnail selected from a browser navigation bar 400 in an embodiment of the present invention. Hovering the mouse cursor over a thumbnail image results in display of an enlarged image 402 of the thumbnail, however, the enlarged image 402 is non-live, in that it is an enlargement of the thumbnail from the archive. In another embodiment, the enlarged view is not a still thumbnail but a view of the archived resource page content in a zoomed out browser window of a fixed or changeable size. In yet another embodiment, the enlarged image of the thumbnail is accessed by selecting the view of the archived content from a virtual menu that appears as the user hovers the mouse cursor over the thumbnail image. Other options in the menu may include access to the map view of the trail, access to a “trail player” and access to a “trail editor”, etc.

A trail player module provides a browser window that automatically displays all the visits in the trail in the order in which the visits were recorded. Each set of visits may be associatively stored in a labeled set (e.g., “Hawaii Trip Sites”). In one embodiment, the trail player module is equipped with editing functions that allows the user to simply discard elements of the trail or add visits from another trail and save or send the trail to other users. If the trail is related to a search query, the trail player module can also highlight query terms or characteristics in the contents of the visited pages. In another embodiment, the last query or a selected query can be used for highlighting the displayed contents. A trail editor module allows a user to edit a labeled set (e.g., deleting, reordering, or supplementing a visit) and resaving the labeled set.

In contrast, single clicking on a thumbnail image causes the non-live version of the resource page to be displayed in the main browser window and double-clicking on a thumbnail performs a live retrieval of the resource page and adds the newly accessed resource page to the current web trail.

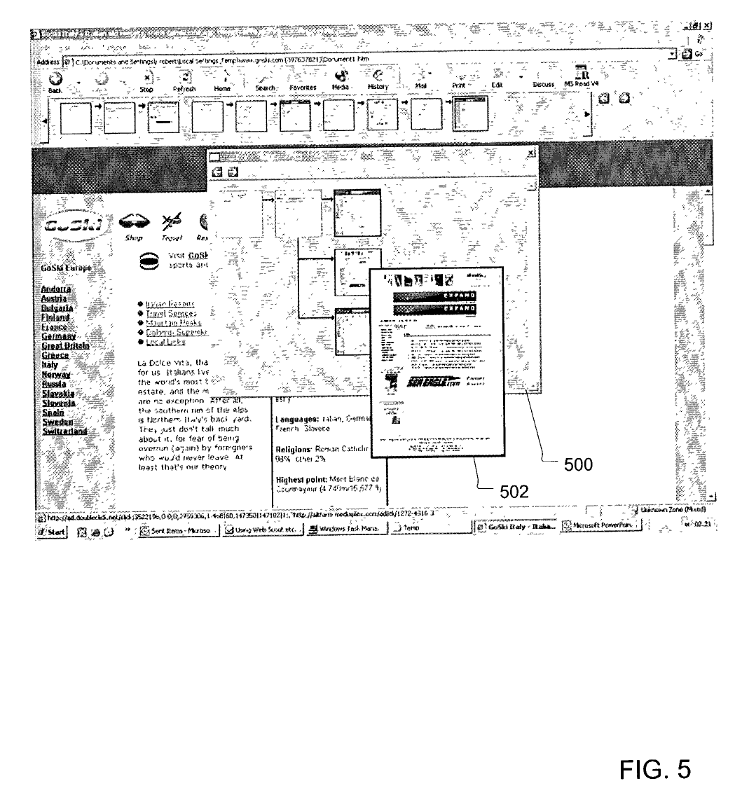

FIG. 5 depicts an enlarged view of a thumbnail selected from a browser session navigation map 500 in an embodiment of the present invention. Hovering the mouse cursor over a thumbnail image results in display of an enlarged image 502 of the thumbnail, however, the enlarged image 502 is non-live, in that it is an enlargement of the thumbnail from the archive. In contrast, single clicking on a thumbnail image causes the non-live version of the resource page to be displayed in the main browser window and double-clicking on a thumbnail performs a live retrieval of the resource page and adds the newly accessed resource to the current web trail.

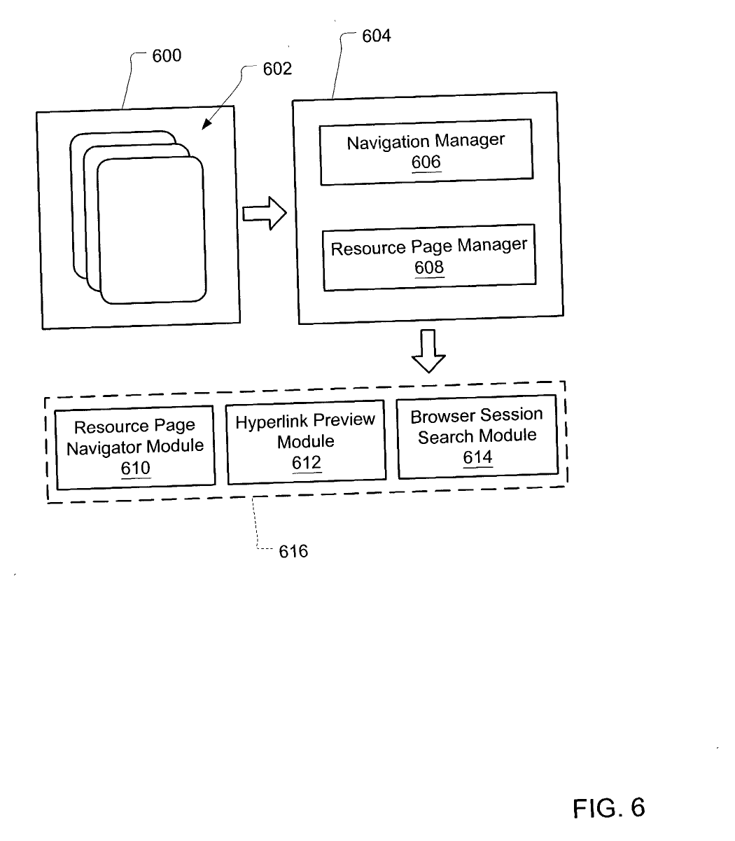

FIG. 6 depicts an architectural diagram of a browser session navigation tool in an embodiment of the present invention. A browser 600 (e.g., a web browser) displays resource pages 602 (e.g., web pages, files, directories, computers, etc.) in a main browser window. Browser and user interface events from active browser windows are communicated from the browser 600 to underlying services 604 to effect browser session navigation functionality.

One such service is a navigation manager 606, which creates and stores the rich record of a user's navigation during a browser session. In one embodiment, the navigation record includes information regarding navigation events and objects, including the type and time stamp of a navigation event, local and remote references to objects (e.g., URLs and local paths to of resource pages), and any metadata associated with the navigation (e.g., search queries, user annotations, device or environment specific parameters, etc.). The navigation record is stored, in part, for use in displaying various views (such as a trail or a map) of the navigation during a browser session.

Another such service is a resource page manager 608, which performs loading and analyses of the resource pages accessed through the browser 600. The types of analysis can include without limitation page layout analysis, text content processing, thumbnail image creation, and color scheme analysis. The resource page manager 608 also manages storage of archive data so that other modules 616 can access, further analyze, and present the analysis to the user in various forms. For example, a resource page navigator module 610 accesses the archive data to present the browser session navigation bar and/or map views to the user.

Another module may perform a thumbnail color analysis in a browser sessions search module 614 to allow a user to search a page with a specific color characteristic. Such functionality is described in further detail in U.S. patent application Ser. No. ______, entitled “RESOURCE BROWSER SESSIONS SEARCH” [Docket No. MS#192134.1/40062.184US01].

Yet another module may include a hyperlink preview module 612 to allow a user to preview a web page associated with a hyperlink in a miniature preview window. Such functionality is described in further detail in U.S. patent application Ser. No. ______, entitled “HYPERLINK PREVIEW UTILITY AND METHOD” [Docket No. MS#192135.1/40062.185US01].

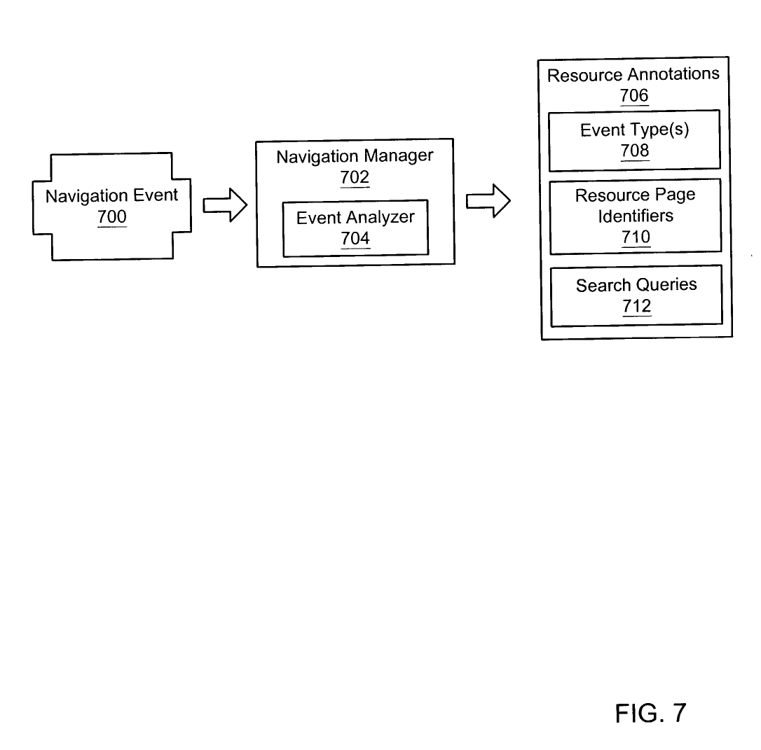

FIG. 7 illustrates functionality of a navigation manager in an embodiment of the present invention. A navigation event 700 is detected by the navigation manager 702 (e.g., receiving a navigation event in an event handler). In one embodiment, the navigation event 700 may include without limitation:

(1) a resource page access event caused by providing a URL for a resource (e.g., in an address bar);

(2) a resource page access event caused by selection of a hyperlink within the browser;

(3) a resource page access event caused by execution of a search query (e.g., via a search engine web page) or a request to access an on-line service (e.g., logging into a service site, etc.);

(4) a resource page access event caused by selection or execution of a hyperlink from another application (e.g., from an e-mail message or other document type);

(5) a resource page access event caused by selection of the Back/Forward navigation features in a browser; or

(6) a resource page access event caused by selection of a resource identifier from a list of recently accessed resources (e.g., via a standard history list or Favorites list).

However, in one embodiment of the present invention, live navigation events result in addition of one or more new visit nodes in a trail or map, whereas non-live navigation events do not. For example, navigation events that result in an access to a live resource page, such as an execution of a link on a page, causing an addition of a new visit node to a trail or map. Similarly, an explicit HTTP (Hypertext Transfer Protocol) request for retrieving a live web page can result in creating a whole new trail, including the requested page thumbnail as the first node. In contrast, using the back/forward features of a browser to traverse through previously visited nodes results in access to an archived (non-live) resource page and, therefore, does not result in an addition to a trail or map. In another embodiment, when a back/forward feature is used to traverse to a previously visited node and the user executes a live navigation from the previously visited node to a new node, both a duplicate of the previously visited node and the new visit node are added to the trail, but only the new node is added to the map, on a new branch. Furthermore, if the user accesses an archived page in one of the previous trails and navigates away from that node by executing a link on the archived page, a new trail is started by creating the reference (e.g., a thumbnail image) of the re-visited page and the newly accessed page. In yet another embodiment, all navigation events result in additions to the trail, even those caused by archive retrievals.

When an event is triggered or accompanied by a web search query or a user selected topic, that event is analyzed by an event analyzer 704 and the corresponding resource page (e.g., the search result page and/or the search engine page) is annotated by the query or the topic to facilitate revisiting of the search result page or the resource page associated with the topic. For example, a page may be annotated (see event annotations 706) with one or more relevant event types 708, including without limitation: hyperlink selection, open in new window, form submission (which includes a query), back/forward, selection from favorites, selection from history, selection from address bar list, browsing to a URL typed into the address bar, pop-up windows, and auto-refresh. Furthermore, a page may also be annotated with resource page identifier(s) 710 (e.g., a URL, a user-selected topic or a user specified label) or web search query terms 712 corresponding to either the page or the event.

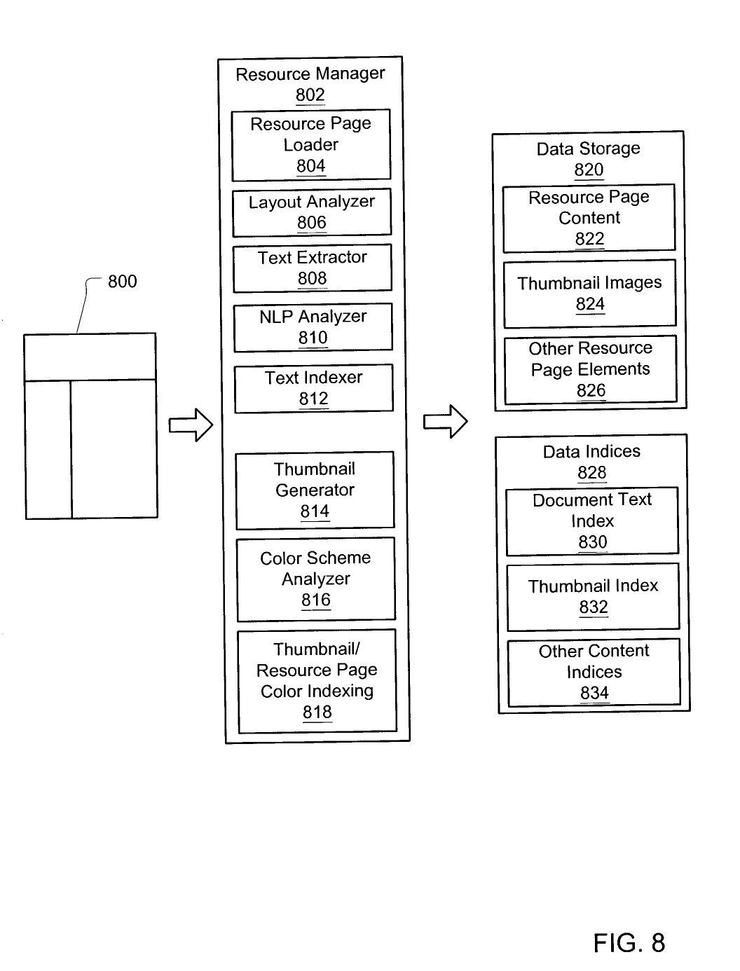

FIG. 8 illustrates functionality of a resource page manager with respect to the accessed resource page content in an embodiment of the present invention. When a resource page 800 (depicted as a web page having three component web documents separated by frames) is received by the browser, the resource page includes at least one resource page identifier and a time stamp. In the exemplary resource 800, the three component documents are identified by individual URLs. A resource page manager 802 processes resource pages that are loaded by the browser, using one or more internal modules to accomplish such processing.

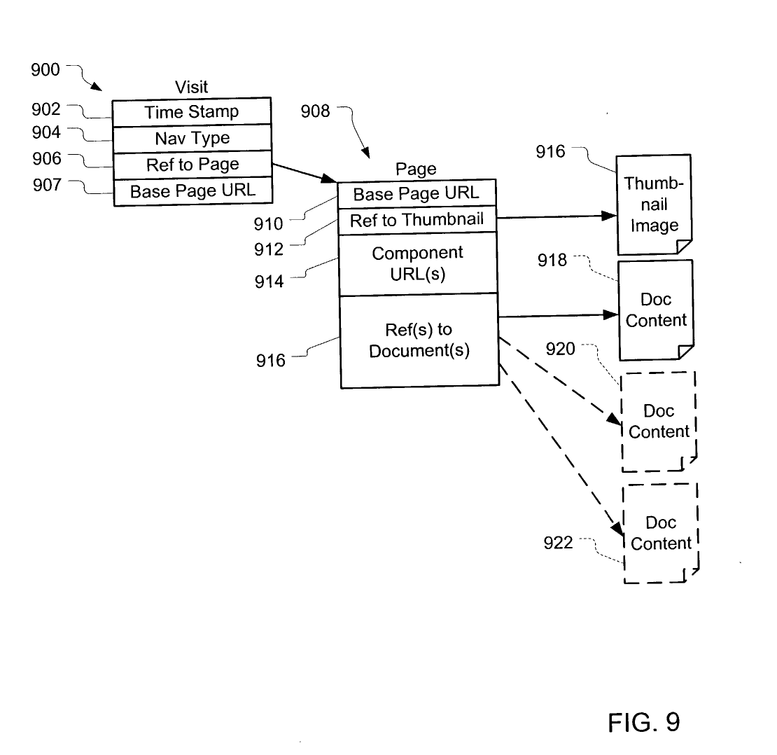

A resource page loader module 804 captures a view of the resource page 800, storing the resource page content, including multiple documents of multi-frame page layouts, into the resource page content portion 822 of the data storage 820. See the exemplary visit and page data structures of FIG. 9 for more detail.

A layout analyzer module 806 analyzes and stores various logical components of the resource page (e.g., component images and links associated with banner advertisements). The layout analyzer module 806 identifies characteristics of the document and object within the document that would be exposed to a user (such as elements that the user can search or view independently). The layout analyzer module 806 analyzes the layout of the viewed resource page and the geometric characteristics of the rendered display of the resource page. For some web pages, for example, the layout analyzer module 806 analyzes the HTML document object model (DOM). The analysis determines the logical structure of the resource page, including the identification of elements that the user may wish to search on or browse through, such as titles, menus, advertisements, images, hyperlink anchor text, etc.

A text extractor module 808 extracts the text from the resource page 800 using known lexographical and parsing techniques. A natural language processing (NLP) analyzer module 810 examines the extracted text and may include one or more linguistics tools, ranging without limitation from a simple stemming tool to a deep syntactic and semantic analysis tool, depending on the performance requirements (i.e., speed and accuracy). For example, for simple highlighting of text in a document, segmenting text into sentences and words may be sufficient. In contrast, for summarizing a document, a complete syntactic and semantic analysis may be applied. Text analysis results may be persisted in the resource page content portion 822 of data storage 820, such as metadata in XML (eXtensible Markup Language), another Web publishing format or even general publishing formats.

The extracted text is indexed by a text indexing module 812, which stores information about the resource page that will be used for retrieving the document. In one embodiment, indexing for standard information retrieval (IR) is employed, although in another embodiment, additional features are implemented. For example, indexing is performed to take into account the structural and logical units of the document content, such as indexing on the anchor text of the hyperlinks, URLs, image captions, headings, etc. The text indices are stored in the document text index portion 830 of the data indices storage 828 to facilitate text searching and resource page retrieval. Generally, the type of index is determined by the type of resource in use. For example, if a resource is a structured set of equipment, an appropriate index may consist of a simple list of resource IDs and equipment names, or similar user recognizable labels.

A thumbnail generator module 814 creates a thumbnail image from the resource page 800 and stores the thumbnail image in the thumbnail images portion 824 of the data storage 820. The thumbnail generator module 814 captures the image rendered by the browser. The thumbnails are created by capturing a snapshot image from the browser-display content and scaling the snapshot image down to appropriate thumbnail size. One method of scaling down the image involves computing for every thumbnail pixel and average color corresponding to multiple pixels in the original browser-displayed image.

A color scheme analyzer module 816 analyzes the thumbnail and/or color scheme of the resource page 800. Color schemes of the resource page 800 can be captured by analysis of the resource page representation. For example, if the resource page 800 is a web page, the color scheme can be captured by analysis of the HTML document that defines the web page, such as by counting the number of pixels of each color in a given region of the web page.

A thumbnail/resource page color indexing module 818 indexes the analyzed thumbnail and/or color schemes and stored the indices in the thumbnail image index portion 832 and the other content indices portion 834 of the data indices storage 828 to facilitate searching. The color information extracted by the color scheme analyzer module 816 is stored in a searchable index, where a search may be conducted by “query by example” or filtering of the result based on the position of the search color on the resource page. For example, if the user remembers that a dark green banner advertisement was located at the top of a previously viewed web page, the user may search for the dark green color at the top of a web page, based on appropriate search criteria input.

FIG. 9 illustrates an exemplary resource data view of a visit in an embodiment of the present invention. A visit data structure 900 represents a visit node in a trail or a map. For each navigation event that results in a visit node, a visit data structure 900 is created and added to the trail or map. A time stamp value 902 specifies the time the navigation event was detected. The “nav type” value 904 specifies the type of navigation event (e.g., back, forward, hyperlink, URL entry, etc.). Note: “Nav types” are described as “event types” with regard to the discussion of FIG. 7. On the basis of these Nav types, navigation sequences associated with a given visit data structure may be dynamically reconstructed. Indeed, that can be facilitated by storing with the navigation event “hyperlink execution” both the identifier of the newly accessed page and the unique identifier of the page from which the hyperlink has been executed. A “ref to page” value 906 specifies a reference (e.g., pointer) to a page data structure (such as page data structure 908) that defines the resource page visited.

In one embodiment, a unique visit identifier 907 is also stored in the visit data structure 900. A unique visit identifier incorporates a signature that uniquely identifies the contents of the accessed resource page and is relevant in cases when the resource changes with time and the storage of the newly retrieved, if only slightly changed, resource page content is required. The signature is used to verify whether the whole accessed page or any component thereof has previously been retrieved and stored in the archive for reuse. A unique signature is generated for each archived resource page, or for individual constituent parts of each resource page. Comparison of content signatures enables optimization of the storage space and archival management (e.g., by eliminating pages or constituent parts thereof that were previously accessed and archived but do not significantly differ from the resource page target of the current navigation request). Exemplary signatures may include without limitation time stamps, hash keys, encryption keys, or serialized forms of such resources and constituent parts.

In the page data structure 908, a base page URL value 910 specifies the location of the resource page (note that the URL value may, for example, also specify a pathname in a local file system). The base page URL value 910 identifies the resource page location. A “ref to thumbnail” value 912 references a thumbnail image 916, which is displayed in the visit node of a trail of the browser session navigation bar or a tree of the browser session navigation map. In one embodiment, the reference to the thumbnail image 916 is a local pathname into the thumbnail content portion of the archive data storage. References to such resource pages, resource page locations, and thumbnail images allow the tool to reuse duplicative data storage. For example, repeated visits to the same web site can result in the reuse of the archived web page content, URL, and thumbnail image, merely by referencing the existing archive storage for these elements.

If there are multiple resource documents in the base resource page (e.g., in a multi-frame web page), the component URL values 914 are listed in the page data structure 908. The component URL values 914 specify the location(s) of the component resource document(s) of the resource page. The page data structure also includes one or more references 916 to the base resource document storage 918 and component resource document stores 920 and 922. It should be understood that document content stores 920 and 922 are shown using dashed lines to indicate that, in some configurations, only a single document content storage is referenced. In one embodiment, the references to the document content stores 916, 920, and 922 are local pathnames into the resource page content portion of the archive data storage.

Each visit data structure is navigationally related with other visit data structures, as indicated by the “nav type” value 904. The visit data structures are stored in a set of visit data structures for a browser session, such as in a linked list. In addition, a new visit data structure is added to the set of visit data structures upon each navigational event, although for non-live retrievals, a new page data structure need not be created. Instead, a new visit data structure is created and added to the list of visits in the browser session, and the new visit data structure merely references the previously retrieved page data structure. Furthermore, creation of a new visit data structure does not require creation of a new visit node in either the browser session navigation bar or the browser session navigation map.

Moreover, it is also common for one document in a multi-frame page to change without other documents in the same page changing. For example, by selecting a bookmark in a table of contents of one frame, the document in the other frame may change to display the selected chapter. In such circumstances, a new visit data structure and a new page data structure are created, but the unchanged component document content stores (e.g., the table of contents document) are merely referenced by the new page data structure without duplicating the document content storage. The changed component document content, however, is created by the resource page manager, stored in the resource page content portion of archive data storage, and referenced from the new page data structure.

Annotations can be created and stored on many different levels, including without limitation at a visit level, with any constituent part of the resource content associated with the visit, at a page level (i.e., the Web location referred to by the URL), with a sequence of pages (e.g., a trail or other derived sequence or set of pages), and at a session level (e.g., in association with an identified browser session). Visual representations (e.g., thumbnails) and content analysis results relating to a resource are represented as annotations on the visit level, although other levels are also contemplated within the scope of the present invention. Such annotations may be stored in the visit data structure or directly in the data structures associated with services that use these annotations (e.g., into a searchable index of the various search services). With such storage, in one embodiment of the present invention, the logical connection with the visit is maintained via URL and the time stamp, although other logical connections may be employed within the scope of the present invention.

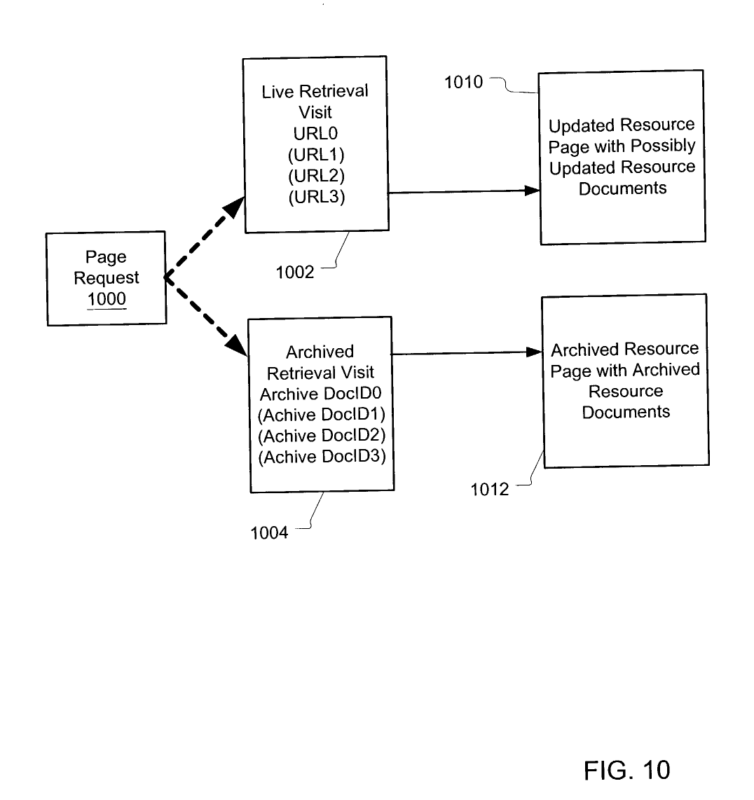

FIG. 10 illustrates two exemplary requests for a resource page in an embodiment of the present invention. A page request 1000 is a navigation event requesting a resource page. In a first example, the request 1000 results in a live retrieval of the resource page. Accordingly, a visit data structure 1002 for a live retrieval visit is created and populated having a time stamp for the event, a nav type value and a reference to a page data structure 1010.

In one implementation, the navigation information is captured and managed by the navigation manager and stored separately from the visit information. The logical correspondence to the visit data is maintained via URL and time stamp. An alternative embodiment stores navigation information within the visit data structures. Furthermore, navigation sequences, such as trails, are derived by analyzing the navigation record and may be created on demand. Alternatively, a navigation sequence may be stored for efficient presentation to the user, such as in associations or sequences of visit data structures or references to visit data structures.

In addition, stored navigation sequences may be annotated by the user, so as to label or bookmark the sequence for later recall. For example, a stored navigation sequence may be labeled “My Financial Page Review” and be stored or bookmarked. Thereafter, the user can recall the sequence to examine the archived information in greater detail. Alternatively, the user can annotate the sequence such that the order and pages of the sequence is preserved, but the content of each page is updated with a live retrieval. Stored navigation sequences can be edited (i.e., deletion of a visit) and re-saved under a different sequence identifier or label. Saved sequences may also be emailed (e.g., by attachment) to other users.

As a live retrieval, the resource page is retrieved from its resource location based on the base URL (e.g., URL0), which was specified in the page request 1000 (e.g., by a hypertext link selection, by an HTTP request submission that generates a result page URL, etc.). In an alternative embodiment, the resource page manager may determine that the requested live resource page is unchanged from a previous visit, although this functionality may be configurable. Page signatures may be used to determine if the resource page has changed. If the resource page manager determines that the base resource document is unchanged from a previous visit, the reference to the base resource document in the page data structure 1010 merely points to the previous instance of the resource page document in the archived storage. Otherwise, the newly retrieved base resource page document is recorded in the archive and referenced by the page data structure 1010 in the archive, which is in turn referenced by the visit data structure 1002. In one embodiment, the page data structure 1010 references the base resource page document using document identifiers (e.g., DocID0), which may take various forms, including without limitation file system path names or.Globally Unique Identifiers (GUIDs). If the base URL specifies the only document in the requested resource page, then no component resource documents need to be processed or stored in the page data structure 1010.

If the base URL specifies a resource document having component resource documents, then the page loader also retrieves the component resource documents based on the component URLs (e.g., URL1-URL3) specified in the resource document of the base URL. Again, the resource page manager may determine that the live component resource documents are unchanged from a previous visit, although this functionality may be configurable. If the resource page manager determines that one or more of the component resource documents are unchanged from a previous visit, references to the component resource documents merely point to the previous instances of the component resource documents in the archived storage. Otherwise, the newly retrieved component resource documents are recorded in the page data structure 1010 in the archive, which is referenced by the visit data structure 1002.

The resource page manager generates a thumbnail image of the resource page (including the base resource document and any component resource documents), stores the thumbnail image in the thumbnail images portion of the archive data storage, and inserts the reference to the thumbnail image into the page data structure 1010.

In contrast, if the request 1000 results in retrieval of a resource page from the archive, there may be no need for a live retrieval of any resources. For example, a user may use the Back feature to return to the previously viewed resource page in the navigation sequence. Accordingly, a visit data structure 1004 for an archived retrieval visit is created and populated as a near duplicate of the previously created visit having its own time stamp for the visit event, its own nav type value (e.g., “BACK”), and a duplicated reference to a page data structure 1012. As an archived retrieval, the resource page documents are merely referenced in the archive. In one embodiment, the page data structure 1012 references a base archived resource document using a base document identifier (e.g., DocID0). Likewise, any component resource documents are also referenced from the page data structure. The thumbnail image of the resource page (including the base resource document and any component resource documents) are also referenced from the page data structure 1012.

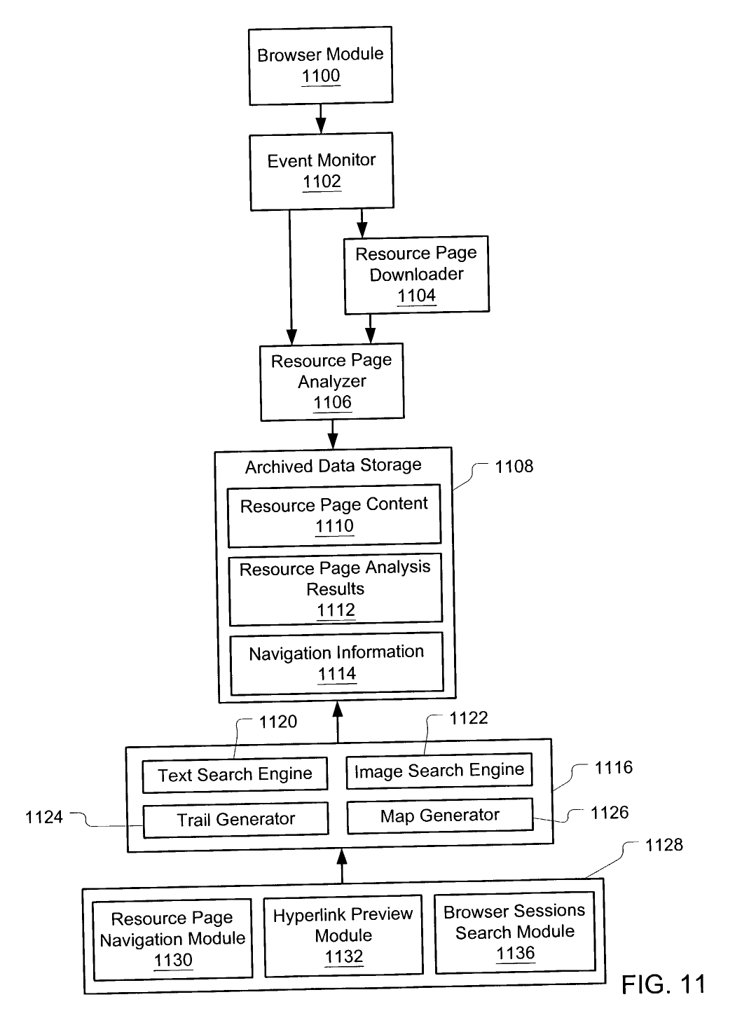

FIG. 11 illustrates processes and services of a browser session navigation tool in an embodiment of the present invention. A browser module 1100 receives user input or network communications that result in a navigation event. An event monitor 1102 in the navigation manager detects the navigation event. If the browser is invisible, the resource page associated with the navigation event is downloaded by the resource page downloader 1104 before page analysis by the resource page analyzer 1106. Otherwise, if the browser is visible, page analysis is performed without downloading by the resource page downloader 1104. Note: in one embodiment, an “invisible” browser is used in the implementation of thumbnail creation, although in other embodiments the use of “invisible” browsers may not be required.

The resource page analyzer 1106 in the resource page manager captures the resource page content and creates a thumbnail image for use in a navigation bar or map. In addition, the resource page analyzer 1106 is also capable of performing layout and logical structure analysis, which can be used in history searches.

The event monitor 1102 and the resource page analyzer 1106 store the resource page content, various resource identifier, the thumbnail image, various indices, analysis results, and navigation event information in the archived data storage 1108. The resource identifiers, resource page content and thumbnail images are stored in the resource page content portion 1110 of the archived data storage 1108. The indices and other analysis results are stored in the resource page analysis results portion 1112 of the archived data storage 1108. The navigation event is stored in the navigation information portion 1114 of the archived data storage 1108.

Several services 1116 can access the archived data storage 1108 to service features 1128, such as a resource page navigation module 1130, a hyperlink preview module 1132, and a browser sessions search module 1136. Each feature 1128 uses the one or more services 1116 to obtain browser session navigation information. A text search engine service 1120 processes text search queries from the resource page navigator module 1130 and the browser sessions search module 1134. Likewise, an image search engine service 1122 processes color and visual aspect search queries from the resource page navigator module 1130 and the browser sessions search module 1136. A trail generator 1124 processes and provides data for display of visit trails. A map generator 1126 processes and provides data for display of visit trees.

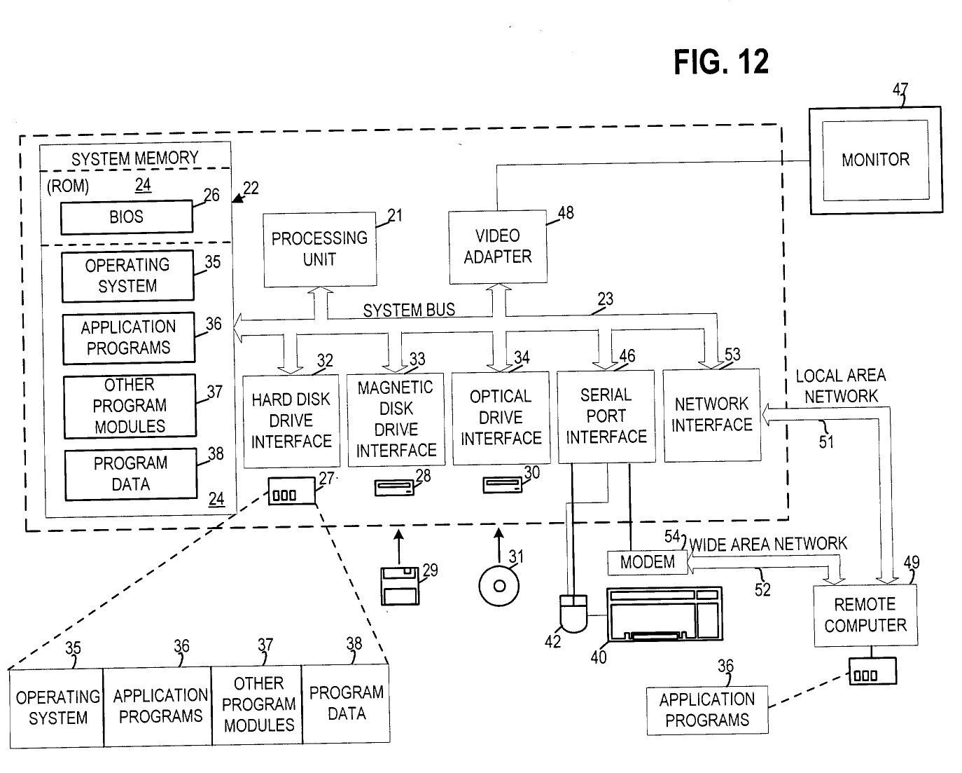

The exemplary hardware and operating environment of FIG. 12 for implementing the invention includes a general purpose computing device in the form of a computer 20, including a processing unit 21, a system memory 22, and a system bus 23 that operatively couples various system components include the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 12. The logical connections depicted in FIG. 12 include a local-area network (LAN) 51 and a wide-area network (WAN) 52. Such networking environments are commonplace in office networks, enterprise-wide computer networks, intranets and the Internal, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52, such as the Internal. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

In an embodiment of the present invention, an browser session navigation tool of the present invention, including the resource page manager, the navigation manager, the resource page navigator module, the browser sessions search module, and the hyperlink preview module may be incorporated as part of the operating system 35, application programs 36, or other program modules 37. The visit data structures, page data structures, and content data stores associated with the navigation tool may be stored as program data 38.

The embodiments of the invention described herein are implemented as logical steps in one or more computer systems. The logical operations of the present invention are implemented (1) as a sequence of processor-implemented steps executing in one or more computer systems and (2) as interconnected machine modules within one or more computer systems. The implementation is a matter of choice, dependent on the performance requirements of the computer system implementing the invention. Accordingly, the logical operations making up the embodiments of the invention described herein are referred to variously as operations, steps, objects, or modules.

The above specification, examples and data provide a complete description of the structure and use of exemplary embodiments of the invention. Since many embodiments of the invention can be made without departing from the spirit and scope of the invention, the invention resides in the claims hereinafter appended.

What is claimed is:

1. A computer program product encoding a computer program for executing on a computer system a computer process for recording browser navigation activity, the computer system including an archive memory and being capable of accessing a plurality of resource pages, the computer process comprising:
detecting a navigation event indicating a visit to one of the plurality of resource pages;
populating a visit data structure representing the visit to the resource page, responsive to the detecting operation;
recording the visit data structure; and
referencing a page data structure that references content of the resource page, responsive to the detecting operation, the content of the resource page being persisted in the archive memory.

2. The computer program product of claim 1 wherein the recording operation comprises:
adding the visit data structure to a sequence of visit data structures representing the navigation activity.

3. The computer program product of claim 2 wherein the computer process further comprises:
associatively storing the sequence of visit data structures as a labeled set.

4. The computer program product of claim 3 wherein the computer process further comprises:
restoring the sequence of visit data structures by loading the labeled set.

5. The computer program product of claim 3 wherein the computer process further comprises:
editing the sequence of visit data structures recorded as the labeled set; and
re-saving the edited sequence of visit data structures as another labeled set.

6. The computer program product of claim 2 wherein the sequence of visit data structures are navigationally related in one or more browser sessions.

7. The computer program product of claim 1 wherein the populating operation comprises:
recording a unique signature in the visit data structure to uniquely identify the visit to the resource page.

8. The computer program product of claim 1 wherein the populating operation comprises:
recording a navigation type in the visit data structure to identify a relationship of the visit to other visits in a navigation sequence.

9. The computer program product of claim 1 wherein the computer process further comprises:
creating the visit data structure, responsive to the detecting operation.

10. The computer program product of claim 1 wherein the computer process further comprises:
displaying the resource page referenced by the visit data structure in a main browser window.

11. The computer program product of claim 1 wherein the computer process further comprises:
generating a thumbnail image of the resource page; and
displaying the thumbnail image in a linear representation of navigationally related visit nodes.

12. The computer program product of claim 1 wherein the computer process further comprises:
generating a thumbnail image of the resource page; and
displaying the thumbnail image in a tree representation of navigationally related visit nodes.

13. The computer program product of claim 1 wherein the computer process further comprises:
generating a thumbnail image of the resource page; and
recording the thumbnail image in the archive memory.

14. The computer program product of claim 1 wherein the computer process further comprises:
generating a thumbnail image of the resource page; and
referencing the thumbnail image in the page data structure.

15. The computer program product of claim 1 wherein the navigation event indicates retrieval of a live resource page.

16. The computer program product of claim 15 wherein computer process further comprises:
retrieving the content of the resource page from a communications network.

17. The computer program product of claim 16 wherein the content of the resource page is stored in the archive memory, responsive to the retrieving operation.

18. The computer program product of claim 15 wherein computer process further comprises:
retrieving the content of the resource page from a communications network., the content of the resource page including one or more component resource documents.

19. The computer program product of claim 1 wherein the navigation event indicates retrieval of an archived resource page.

20. The computer program product of claim 19 wherein computer process further comprises:
retrieving the content of the resource page from the archive memory.

21. The computer program product of claim 19 wherein computer process further comprises:
retrieving the content of the resource page from the archive memory, the content of the resource page including one or more component resource documents.

22. The computer program product of claim 1 wherein the computer process further comprises:
searching for a text pattern in resource page content stored in the archive memory.

23. The computer program product of claim 1 wherein the computer process further comprises:
searching for an image characteristic in resource page content stored in the archive memory.

24. A method of recording browser navigation activity, the computer system including an archive memory and being capable of accessing a plurality of resource pages, the method comprising:
detecting a navigation event indicating a visit to one of the plurality of resource pages;
populating a visit data structure representing the visit to the resource page, responsive to the detecting operation;
recording the visit data structure; and
referencing a page data structure that references content of the resource page, responsive to the detecting operation, the content of the resource page being persisted in the archive memory.

25. The method of claim 24 wherein the recording operation comprises:
adding the visit data structure to a sequence of visit data structures representing the navigation activity.

26. The method of claim 25 wherein the computer process further comprises:
associatively storing the sequence of visit data structures as a labeled set.

27. The method of claim 26 wherein the computer process further comprises:
restoring the sequence of visit data structures by loading the labeled set.

28. The method of claim 26 wherein the computer process further comprises:
editing the sequence of visit data structures recorded as the labeled set; and
re-saving the edited sequence of visit data structures as another labeled set.

29. The method of claim 25 wherein the sequence of visit data structures are navigationally related in one or more browser sessions.

30. The method of claim 24 wherein the populating operation comprises:
recording a unique signature in the visit data structure to uniquely identify the visit to the resource page.

31. The method of claim 24 wherein the populating operation comprises:
recording a navigation type in the visit data structure to identify a relationship of the visit to other visits in a navigation sequence.

32. The method of claim 24 wherein the computer process further comprises:
creating the visit data structure, responsive to the detecting operation.

33. The method of claim 24 wherein the computer process further comprises:
displaying the resource page referenced by the visit data structure in a main browser window.

34. The method of claim 24 wherein the computer process further comprises:
generating a thumbnail image of the resource page; and
displaying the thumbnail image in a linear representation of navigationally related visit nodes.

35. The method of claim 24 wherein the computer process further comprises:
generating a thumbnail image of the resource page; and
displaying the thumbnail image in a tree representation of navigationally related visit nodes.

36. The method of claim 24 wherein the computer process further comprises:
generating a thumbnail image of the resource page; and
recording the thumbnail image in the archive memory.

37. The method of claim 24 wherein the computer process further comprises:
generating a thumbnail image of the resource page; and
referencing the thumbnail image in the page data structure.

38. The method of claim 24 wherein the navigation event indicates retrieval of a live resource page.

39. The method of claim 38 wherein computer process further comprises:
retrieving the content of the resource page from a communications network.

40. The method of claim 39 wherein the content of the resource page is stored in the archive memory, responsive to the retrieving operation.

41. The method of claim 38 wherein computer process further comprises:
retrieving the content of the resource page from a communications network., the content of the resource page including one or more component resource documents.

42. The method of claim 24 wherein the navigation event indicates retrieval of an archived resource page.

43. The method of claim 42 wherein computer process further comprises:
retrieving the content of the resource page from the archive memory.

44. The method of claim 42 wherein computer process further comprises:
retrieving the content of the resource page from the archive memory, the content of the resource page including one or more component resource documents.

45. The method of claim 24 further comprising:
searching for a text pattern in resource page content stored in the archive memory.

46. The method of claim 24 further comprising:
searching for an image characteristic in resource page content stored in the archive memory.

47. A resource browser session navigator for recording browser navigation activity in a computer system including an archive memory, the resource browser session navigator comprising:
a navigation manager module detecting a navigation event indicating a visit to a resource page;
a resource page manager module populating a visit data structure representing the visit to the resource page and referencing in the visit data structure a page data structure that references content of the resource page, the content of the resource page being persistent in the archive memory.

48. The resource browser session navigator of claim 47 further comprising:
a text search engine capable of searching for a text pattern in resource page content recorded in the archive memory.

49. The resource browser session navigator of claim 47 further comprising:
an image search engine capable of searching for an image characteristic in resource page content recorded in the archive memory.

50. The resource browser session navigator of claim 47 further comprising:
a trail generator module generating a linear representation of one or more visit nodes, each visit node corresponding to a visit to a resource page.

51. The resource browser session navigator of claim 47 further comprising:
a map generator module generating a tree representation of one or more visit nodes, each visit node corresponding to a visit to a resource page.
